(19) United States
(12) Patent Application Publication
(10) Pub. No.: US 2015/0092456 A1
(43) Pub. Date: Apr. 2, 2015

(54) METHOD FOR SENSING OUTPUT CURRENT OF FLY-BACK CONVERTER

(71) Applicant: LEADER ELECTRONICS INC., New Taipei City (TW)

(72) Inventors: Rene Frederik KOCH, New Taipei City (TW); Sheng-Yu PAI, New Taipei City (TW); Hsi-Hung LU, New Taipei City (TW); Chin-Nan HSIA, New Taipei City (TW)

(73) Assignee: LEADER ELECTRONICS INC., New Taipei City (TW)

(21) Appl. No.: 14/040,441

(22) Filed: Sep. 27, 2013

(51) Int. Cl. H02M 3/335

(52) U.S. Cl. CPC H02M 3/33507
USPC 363/21.12

(57) ABSTRACT

A method for sensing an output current Iₒᵤₜ of the fly-back converter has steps of sensing a voltage U_{S} of the switching node to obtain a time period T_{SW} of a switching cycle of the fly-back converter and a time period T_{OFF} of a OFF stage of the switching cycle; and then calculating the output current Iₒᵤₜ according to a formula

$${I}_{out} = k \frac{{T}_{OFF}^{2}}{{T}_{SW}} ,$$

wherein k is a predictable constant. By the method, a user just need to sense the voltage U_{S} of the switching node of the fly-back converter, and then the output current Iₒᵤₜ of the fly-back converter is obtained by the formula without using a sensing resistor to sense any current in the fly-back converter.

### BACKGROUND OF THE INVENTION

1. Field of the Invention

The present invention relates to a method for sensing an output current of a fly-back converter and more particularly to a method for sensing an output current of a fly-back converter in discontinuous mode without decreasing efficiency of the fly-back converter.

2. Description of Related Art

A fly-back converter is usually used as a low power AC/DC power converter. With reference to FIG. 8, the fly-back converter comprises a primary circuit 30 and a secondary circuit 40. The primary circuit 10 has a rectifier unit 31, a primary coil 32, a primary switch 33, a PWM control unit 34 and a primary capacitor 35.

The rectifier unit 31 is a full-bridge circuit having two input terminals and two output terminals, wherein the input terminals are adapted for being connected to an AC power V_{AC} and the rectifier unit 31 converts the AC power V_{AC} into a pulsating DC power to the output terminals. The primary coil 32 and the primary switch 33 are connected in series between the output terminals of the rectifier unit 31. The PWM control unit 34 is connected to the primary switch 33 and controls an on/off switching of the primary switch 33. The primary capacitor 35 is connected in series between the output terminals of the rectifier unit 31 to reduce ripple caused by the pulsating DC power.

The secondary circuit 40 has two output terminals, a secondary coil 41, a diode 42 and a secondary capacitor 43. The output terminals are adapted for being connected to an electronic device. The secondary coil 41 has two ends. The diode 42 has an anode and a cathode, wherein the anode of the diode 42 is connected to one end of the secondary coil 41, and the cathode of the diode 42 and the other end of the secondary coil 41 are respectively connected to the output terminals of the secondary circuit 40. The secondary capacitor 43 is connected in series between the output terminals of the secondary circuit 40.

When the fly-back converter is connected to an electronic device and the AC power V_{AC} is turned on, the primary coil 32 obtains the pulsating DC power from the rectifier unit 31 and outputs a voltage U_{P}. The secondary coil 41 is induced by the voltage U_{P} and outputs an induced voltage U_{S}. The induced voltage U_{S} is filtered and rectified by the diode 42 and the secondary capacitor 43 to provide an output voltage Uₒᵤₜ to the connected electronic device.

Generally, the output voltage Uₒᵤₜ of the fly-back converter is controlled to a predetermined output voltage, the output current Iₒᵤₜ of the fly-back converter is not fixed, but depending on the state of the connected electronic device. Furthermore, the electronic device is usually connected to the fly-back converter through a cable having an internal resistance. The internal resistance of the cable causes cable losses. In order to adjust the output voltage Uₒᵤₜ to compensate for the cable losses or to protect the connected electronic device, the output current Iₒᵤₜ has to be monitored. Therefore, a current sensing resistor 44 is usually used to sense the output current Iₒᵤₜ of the fly-back converter. The resistor 44 is connected in series with the connected electronic device, and the output current Iₒᵤₜ can be obtained by measuring the voltage difference between two ends of resistor 44. However, when the output current Iₒᵤₜ flows through the resistor 44, the resistor 44 causes losses that decrease the efficiency of the fly-back converter.

### SUMMARY OF THE INVENTION

The main objective of the invention is to provide a method for sensing an output current of a fly-back converter without decreasing the efficiency of the fly-back converter.

A method for sensing an output current of a fly-back converter, wherein the fly-back converter comprises:

a primary circuit having
a rectifier unit having two input terminals and two output terminals, wherein the input terminals are adapted for being connected to an AC power and the rectifier unit converts the AC power into a pulsating DC power to the output terminals;
a primary coil having two ends, wherein one end of the primary coil is connected to one of the output terminals of the rectifier unit;
a primary switch connected with the other end of the primary coil and the other output terminal of the rectifier unit;
a PWM control unit having a built-in operating cycle which makes the fly-back converter having a switching cycle with three stages: ON stage, OFF stage and dead stage, wherein a time period of the switching cycle is T_{SW} and a time period of the OFF stage of the switching cycle of the fly-back converter is T_{OFF}; and
a primary capacitor connected in series between two output terminals of the rectifier unit; and

a secondary circuit having
two output terminals adapted for being connected to an electronic device;
a secondary coil having two ends, wherein one end of the secondary coil is connected to one of the output terminals of the secondary circuit; and
a diode having an anode and a cathode, wherein the anode is connected to the other end of the secondary coil, the cathode is connected to the other output terminal of the secondary circuit, wherein a connected node between the diode and the secondary coil is a switching node;
a secondary capacitor connected in series between two output terminals of the secondary circuit;

the method for sensing the output current Iₒᵤₜ of the fly-back converter in accordance with the present invention comprises the following steps:

sensing the voltage of the switching node to obtain the time period T_{SW} of the switching cycle of the fly-back converter and the time period T_{OFF} of the OFF stage of the switching cycle; and

calculating the output current Iₒᵤₜ with the time period T_{SW} and the time period T_{OFF} according to a formula:

$${I}_{out} = k \frac{{T}_{OFF}^{2}}{{T}_{SW}} ,$$

wherein k is a constant.

In conclusion, by the method for sensing the output current Iₒᵤₜ of the fly-back converter in accordance with the present invention, a user just need to sense the voltage of the switching node to obtain the time period T_{SW} of the switching cycle of the fly-back converter and the time period T_{OFF} of the OFF stage of the switching cycle, and then the output current Iₒᵤₜ of the fly-back converter can be obtained by the formula without sensing any current in the fly-back converter by a sensing resistor.

### BRIEF DESCRIPTION OF THE DRAWINGS

FIG. 1 is a circuit diagram of a first embodiment of a fly-back converter in accordance with the present invention;

FIG. 2A is a waveform chart of a current of a primary coil of the fly-back converter in FIG. 1;

FIG. 2B is a waveform chart of a voltage of a primary coil of the fly-back converter in FIG. 1;

FIG. 2C is a waveform chart of a voltage of a switching node of the fly-back converter in FIG. 1 and an output voltage of the fly-back converter in FIG. 1;

FIG. 2D is a waveform chart of an output current of the secondary coil of the fly-back converter in FIG. 1;

FIG. 3 is an operational circuit diagram of the fly-back converter in FIG. 1, shown operating in an ON stage of a switching cycle of the fly-back converter;

FIG. 4 is an operational circuit diagram of the fly-back converter in FIG. 1, shown operating in an OFF stage of the switching cycle of the fly-back converter;

FIG. 5 is an operational circuit diagram of the fly-back converter in FIG. 1, shown operating in a dead stage of the switching cycle of the fly-back converter;

FIG. 6 is a circuit diagram of a second embodiment of the fly-back converter in accordance with the present invention;

FIG. 7A is a waveform chart of a current of a primary coil of the fly-back converter in FIG. 6;

FIG. 7B is a waveform chart of a voltage of a primary coil of the fly-back converter in FIG. 6;

FIG. 7C is a waveform chart of a voltage of a switching node of the fly-back converter in FIG. 6 and an output voltage of the fly-back converter in FIG. 6;

FIG. 7D is a waveform chart of an output current of the secondary coil of the fly-back converter in FIG. 6; and

FIG. 8 is a circuit diagram of a fly-back converter having a sensing resistor in accordance with the prior art.

### DETAILED DESCRIPTION OF THE PREFERRED EMBODIMENTS

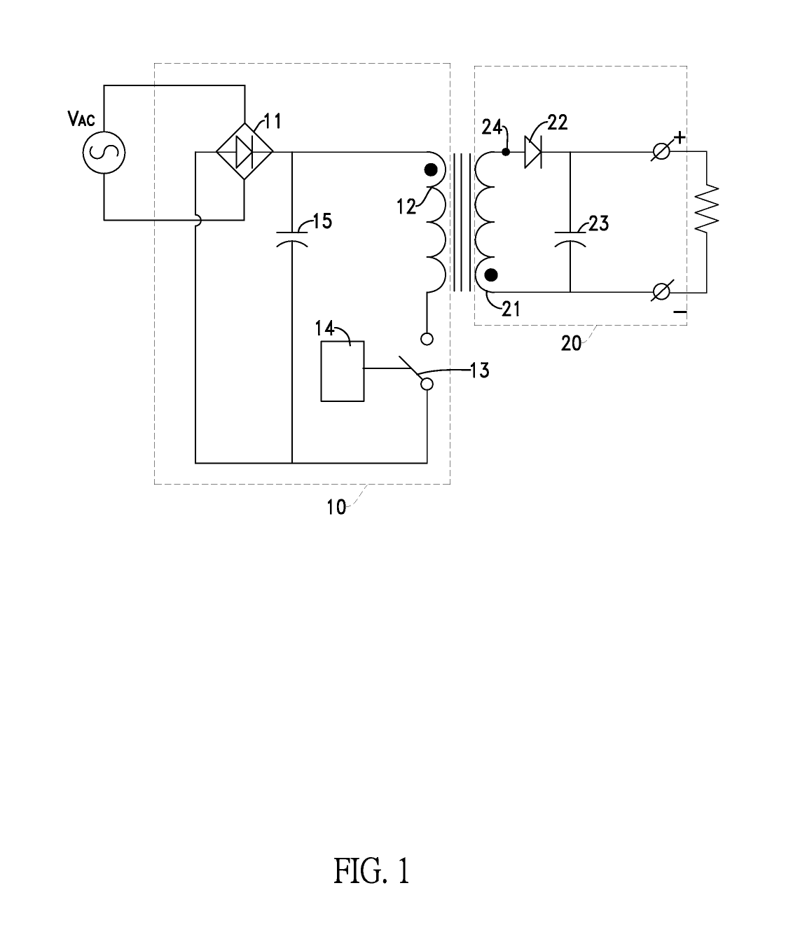

With reference to FIG. 1, a first embodiment of a fly-back converter in accordance with the present invention has a primary circuit 10 and a secondary circuit 20. The primary circuit 10 has a rectifier unit 11, a primary coil 12, a primary switch 13, a PWM control unit 14 and a primary capacitor 15.

The rectifier unit 11 is a full-bridge rectifying circuit having two input terminals and two output terminals, wherein the input terminals are adapted for being connected to an AC power V_{AC} and the rectifier unit 11 converts the AC power V_{AC} into a pulsating DC power to the output terminals. The primary coil 12 and the primary switch 13 are connected in series between the output terminals of the rectifier unit 11. The PWM control unit 14 is electrically connected to the primary switch 13 and controls the switching of the primary switch 13, wherein the PWM control unit 14 has a built-in operating cycle which makes the fly-back converter having a switching cycle with three stages: ON stage, OFF stage and dead stage. The primary capacitor 15 is connected in series between the output terminals of the rectifier unit 11 to reduce ripple caused by the pulsating DC power.

The secondary circuit 20 has two output terminals, a secondary coil 21, a diode 22 and a secondary capacitor 23. The output terminals are adapted for being connected to an electronic device. The secondary coil 21 has two ends and an inductance of the secondary coil 21 is L_{S}. The diode 22 has an anode and a cathode, wherein the anode of the diode 22 is connected to one end of the secondary coil 21, the cathode of the diode 22 and the other end of the secondary coil 21 are respectively connected to the output terminals of the secondary circuit 20, and a forward voltage of the diode 22 is U_{D}. The secondary capacitor 23 is connected in series between the output terminals of the secondary circuit 20. A node between the secondary coil 21 and the diode 22 is a switching node 24 of the fly-back converter.

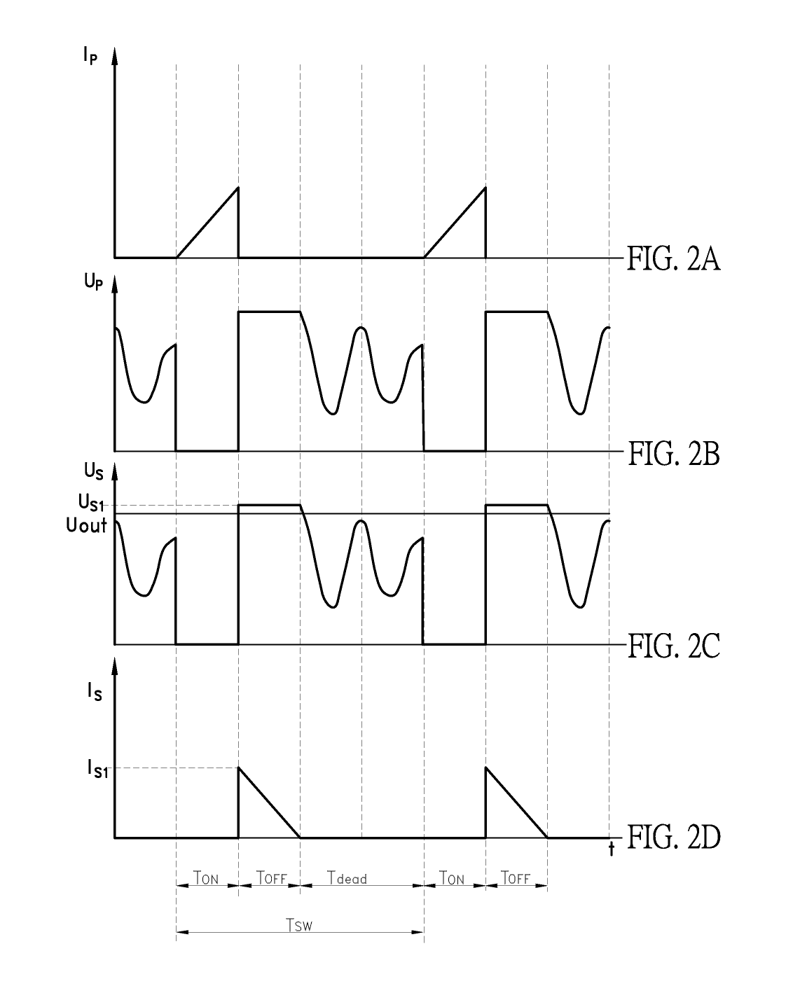

Work statuses of the fly-back converter in different stages of the switching cycle are revealed in the following paragraph. With reference to FIGS. 2A to 2D, a vertical axis in FIG. 2A is a current in the primary coil 12. A vertical axis in FIG. 2B is a voltage U_{P} of the primary coil 12. A vertical axis in FIG. 2C is a voltage U_{S} of the switching node 24, and an output voltage Uₒᵤₜ is a predetermined output voltage of the secondary circuit of the fly back converter. A vertical axis in FIG. 2D is an output current I_{S} of the secondary coil 21. All horizontal axes represent time. A time period of the switching cycle is T_{SW}. A time period of the ON stage is T_{ON}. A time period of the OFF stage is T_{OFF}. A time period of the dead stage is T_{dead}.

Furthermore, by observing FIGS. 2A to 2D one can obtain that the time periods T_{SW}, T_{ON}, T_{OFF}, T_{dead} are determined by the voltage U_{S} of the switching node 24, such that the time periods T_{SW}, T_{ON}, T_{OFF}, T_{dead} can be obtained by sensing the voltage U_{S} of the switching node 24.

The following steps may be used to obtain T_{OFF}, U_{S1} and T_{SW}:

(a) obtaining a first time period during which U_{S} is greater than Uₒᵤₜ by sensing U_{S}, wherein the first time period is defined as T_{OFF} and U_{S} during T_{OFF} is a constant voltage U_{S1}; and

(b) obtaining a second time period from a start of a T_{OFF} to a start of a subsequent T_{OFF}, wherein the second time period is defined as T_{SW}.

Furthermore, a time period from an end of a T_{OFF} to an end of a subsequent T_{OFF} is also defined as T_{SW}.

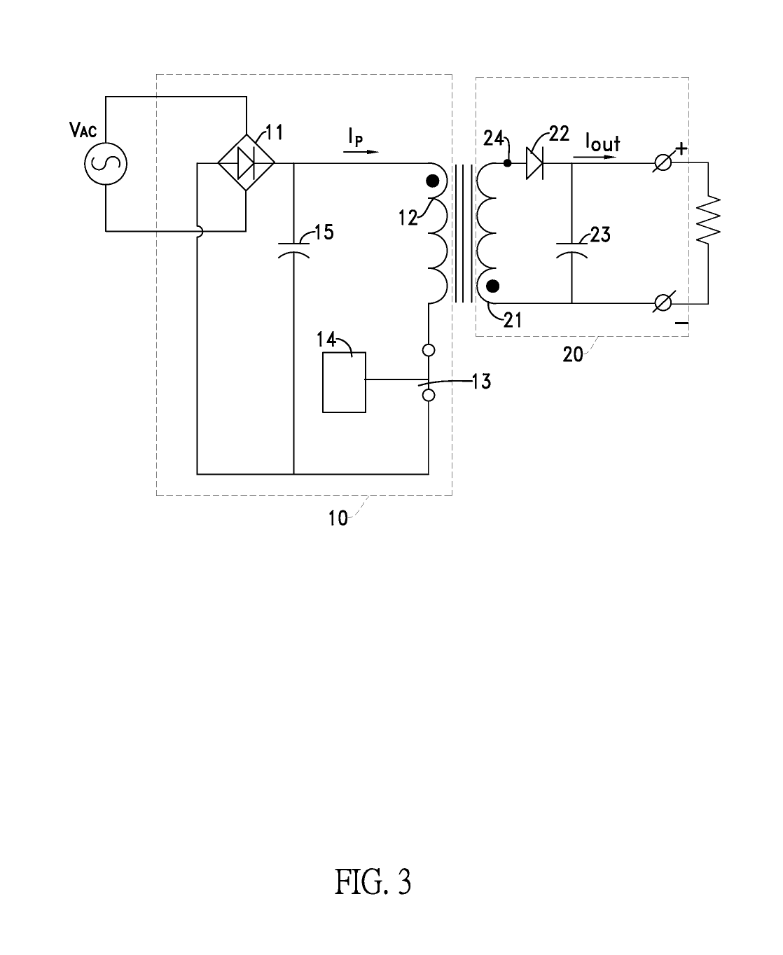

When the fly-back converter is in the ON stage, with further reference to FIG. 3, the primary switch 13 is turned on by the PWM control unit 14 and the rectifier unit 11 forms a primary loop with the primary coil 12 and the primary switch 13. The rectifier unit 11 outputs the current I_{P} flowing through the primary loop. The current I_{P} is gradually increased from 0 A in the ON stage and the primary coil 12 is charged by the current I_{P}. The secondary capacitor 23 forms a secondary loop with the connected electronic device and releases a stored energy. The secondary capacitor 23 outputs an output current Iₒᵤₜ flowing through the secondary loop. The secondary capacitor 23 also outputs the output voltage Uₒᵤₜ to the connected electronic device.

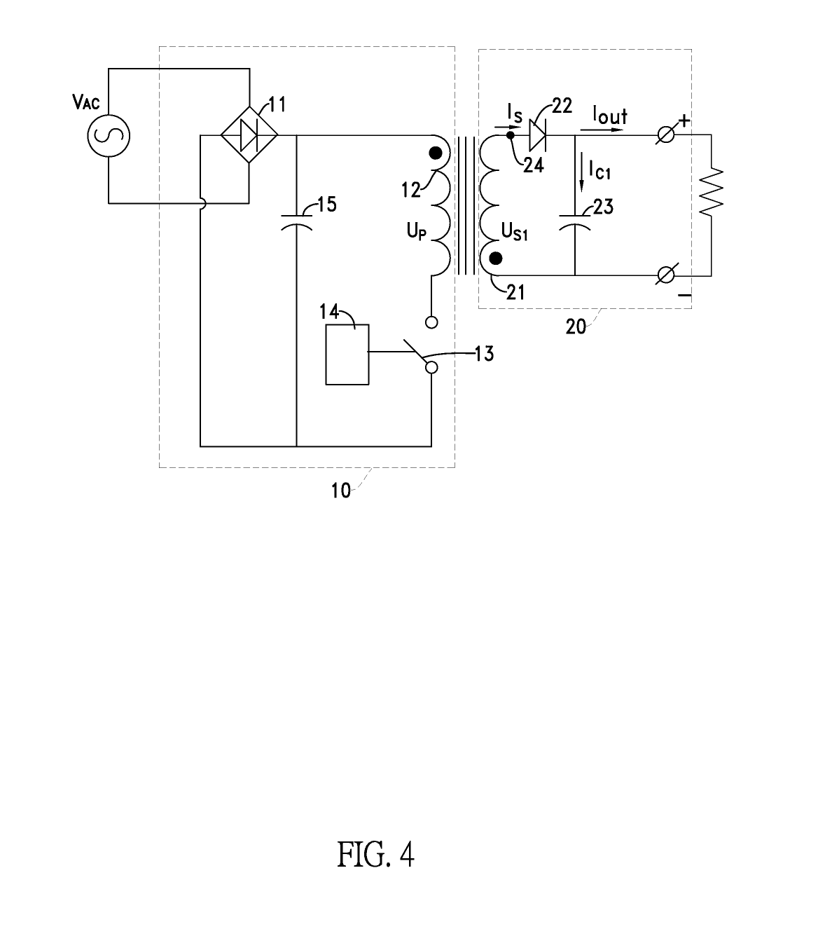

When the fly-back converter is in the OFF stage, with further reference to FIG. 4, the primary switch 13 is turned off by the PWM control unit 14 and the primary loop is open-circuit. The primary coil 12 starts to release energy stored during the ON stage and output a voltage U_{P}. The secondary coil 21 of the secondary circuit 20 is induced by the voltage U_{P} and outputs an induced voltage U_{S1} to the switching node 24. The diode 22 is conducting by the voltage U_{S1} and the secondary coil 21 outputs the induction current I_{S}, and the voltage U_{S1} minus the forward voltage U_{P} is Uₒᵤₜ (U_{S1}−U_{D}=Uₒᵤₜ). The induction current I_{S} is decreased from a high current I_{S1} to 0 A in the OFF stage, and the waveform of the induction current I_{S} is a triangular wave. The induction current I_{S} is shunted into the output current Iₒᵤₜ and a capacitor current I_{C1}, wherein Iₒᵤₜ and I_{C1} respectively flow through the connected electronic device and the secondary capacitor 23. The secondary capacitor 23 is charged by the current I_{C1}.

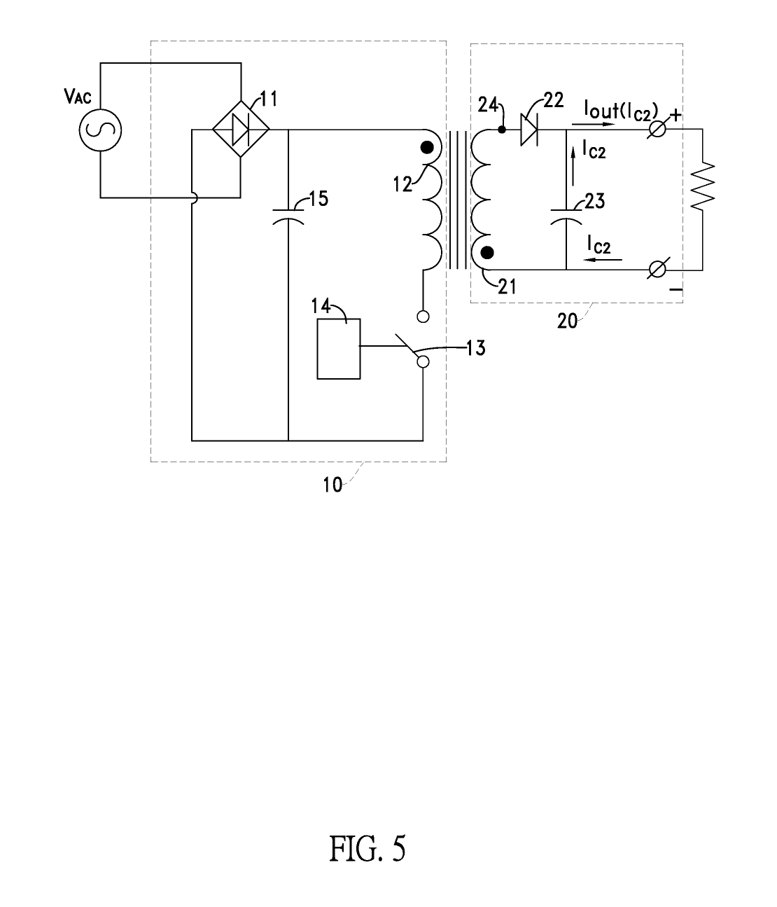

When the fly-back converter is in the dead stage, with further reference to FIG. 5, the primary switch 13 is still off such that the primary loop is still open-circuit. The primary coil 12 releases residual energy and the voltage U_{P} rings. The voltage U_{S} of the switching node 24 also rings and diode 22 stops conducting, such that the secondary coil 21 does not output the induction current I_{S}. The secondary capacitor 23 forms the secondary loop with the connected electronic device again and releases a stored energy. The secondary capacitor 23 outputs the output current Iₒᵤₜ flowing through the secondary loop. The secondary capacitor 23 also outputs the output voltage Uₒᵤₜ to the connected electronic device.

After the dead stage ends, the primary switch 13 is turned on by the PWM control unit 14 and the ON stage starts again to continue the switching cycle of the fly-back converter.

A derivation of a method for sensing the output current Iₒᵤₜ of the fly-back converter in accordance with the invention is revealed in the following paragraph.

The output voltage Uₒᵤₜ is controlled to a predetermined output voltage, and a total output energy Eₒᵤₜ in a single switching cycle of the fly-back converter is Uₒᵤₜ×Iₒᵤₜ×T_{SW}. By observing FIGS. 2C and 2D one can obtain that the secondary coil 21 only outputs the current I_{S} in the OFF stage, that is, the secondary coil 21 only releases energy in the OFF stage of the switching cycle of the fly-back converter. An energy E_{S} released by the secondary coil 21 in an OFF stage of a switching cycle is U_{S1}×I_{Save}×T_{OFF}, wherein I_{Save} is an average induction current I_{S} of the secondary coil 21 in the OFF stage. In addition, diode 22 also consumes a diode energy E_{D} in an OFF stage of a switching cycle due to the forward voltage U_{D}, wherein the consumed diode energy E_{D}=U_{D}×I_{Save}×T_{OFF}. The energy E_{S} released by the coil 21 equals a sum of the output energy Eₒᵤₜ and the diode energy E_{D} in a duty cycle:

E_{S}=Eₒᵤₜ+E_{D}=U_{S1}×I_{Save}×T_{OFF}=Uₒᵤₜ×Iₒᵤₜ×T_{SW}+U_{D}×I_{Save}×T_{OFF}.

(U_{S1}−U_{D})I_{Save}×T_{OFF}=Uₒᵤₜ×Iₒᵤₜ×T_{SW}

By observing FIG. 2D we can obtain that the induction current I_{S} is decreased from a high current I_{S1} to zero in an OFF stage.

$$\frac{{dI}_{S 1}}{dt} = \frac{{U}_{S 1}}{{L}_{S}}$$

$${dI}_{S 1} = \frac{{U}_{S 1}}{{L}_{S}} dt$$

$${I}_{S 1} = \frac{{U}_{S 1}}{{L}_{S}} {T}_{OFF}$$

and the waveform of the induction current I_{S} is triangular wave, that is, the average current

$${I}_{Save} = \frac{1}{2} {I}_{S 1} = \frac{1}{2} \frac{{U}_{S 1}}{{L}_{S}} {T}_{OFF} . \\ \begin{matrix}( {U}_{S 1} - {U}_{D} ) \times \frac{1}{2} {I}_{S 1} \times {T}_{OFF} = \frac{1}{2} \frac{{U}_{S 1}}{{L}_{S}} {T}_{OFF} \times {T}_{OFF} \\ = {U}_{out} \times {I}_{out} \times {T}_{SW}\end{matrix}$$

$$( {U}_{S 1} - {U}_{D} ) \times \frac{{U}_{S 1} {T}_{OFF}^{2}}{2 {L}_{S}} = {U}_{out} \times {I}_{out} \times {T}_{SW}$$

$${I}_{out} = ( {U}_{S 1} - {U}_{D} ) \times \frac{{U}_{S 1} {T}_{OFF}^{2}}{2 {L}_{S} {U}_{out} {T}_{SW}} and ( {U}_{S 1} - {U}_{D} ) equals {U}_{out}$$

$${I}_{out} = ( {U}_{S 1} - {U}_{D} ) \times \frac{{U}_{S 1} {T}_{OFF}^{2}}{2 {L}_{S} {U}_{out} {T}_{SW}} = \frac{{U}_{S 1} {T}_{OFF}^{2}}{2 {L}_{S} {T}_{SW}} ,$$

wherein, the U_{S1} and the L_{S} are all known constants.

The formula can be expressed by

$${I}_{out} = \frac{{U}_{S 1} {T}_{OFF}^{2}}{2 {L}_{S} {T}_{SW}} = k \frac{{T}_{OFF}^{2}}{{T}_{SW}} ,$$

wherein k is a constant and equals

$$\frac{{U}_{S 1}}{2 {L}_{S}}$$

A method for sensing the output current Iₒᵤₜ of the fly-back converter as shown in FIG. 1 in accordance with the present invention comprises following steps:

(a) sensing the voltage U_{S} of the switching node 24 to obtain the time period T_{SW} of the switching cycle of the fly-back converter and the time period T_{OFF} of the OFF stage of the switching cycle; and

(b) calculating the output current Iₒᵤₜ according to formula:

$${I}_{out} = k \frac{{T}_{OFF}^{2}}{{T}_{SW}}$$

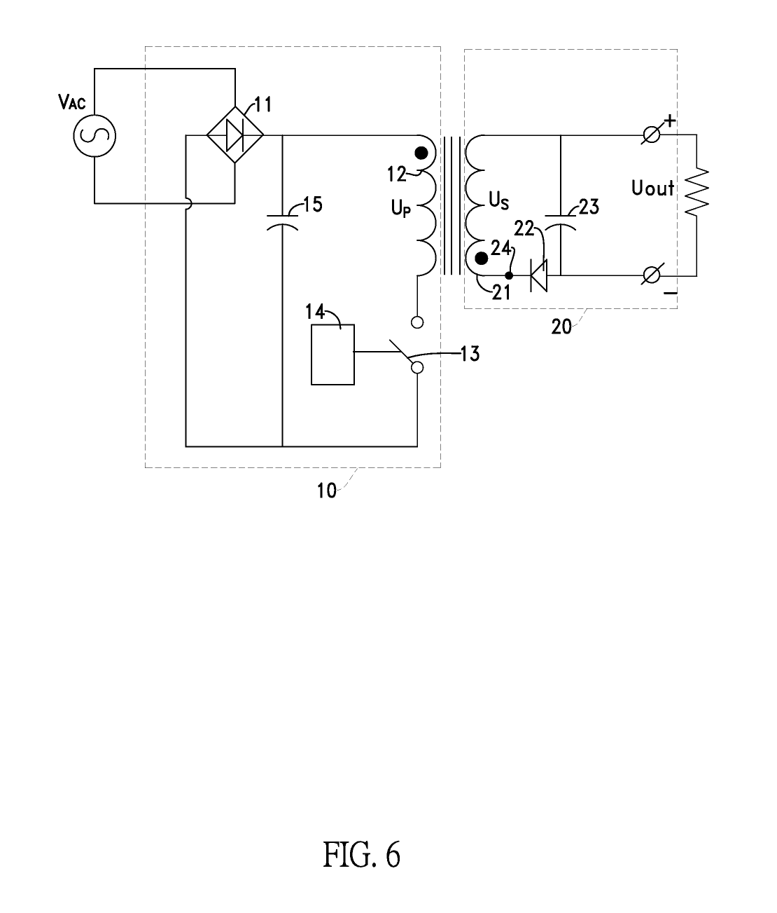

In addition, with reference to FIG. 6, a second embodiment of the fly-back converter is shown. A difference between the fly-back converter and the first embodiment is that the cathode of the diode 22 is connected to one end of the secondary coil 21, the anode of the diode 22 and the other end of the secondary coil 21 are respectively connected to the output terminals of the secondary circuit 20. The node between the secondary coil 21 and the diode 22 is the switching node 24 of the fly-back converter.

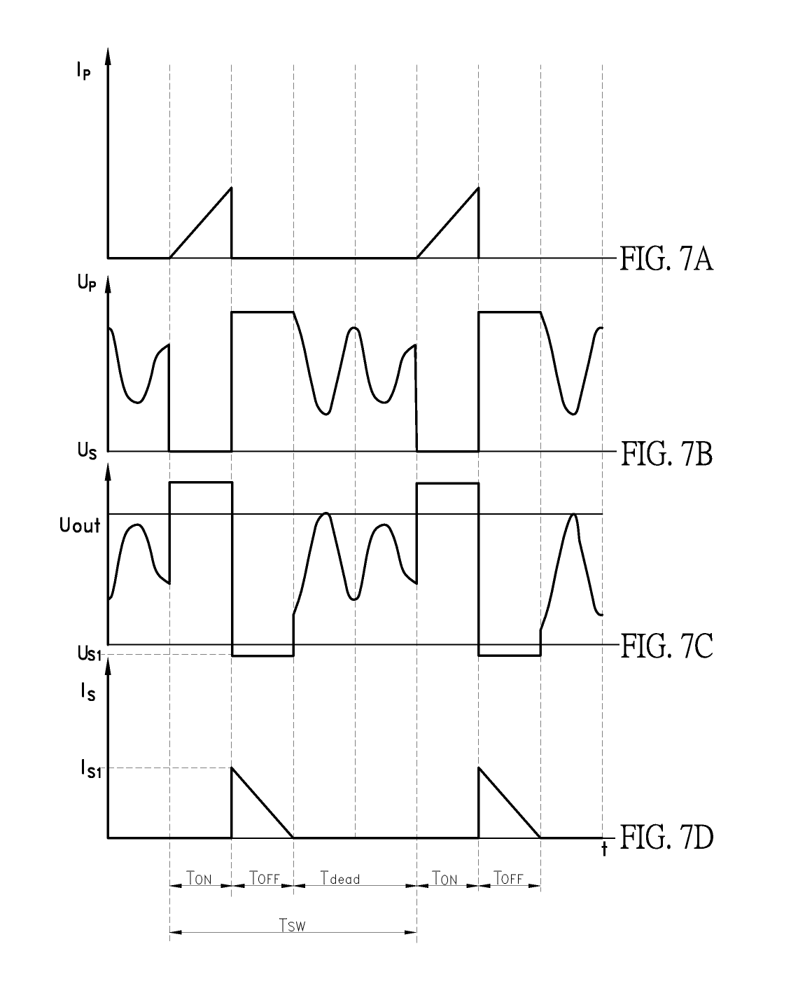

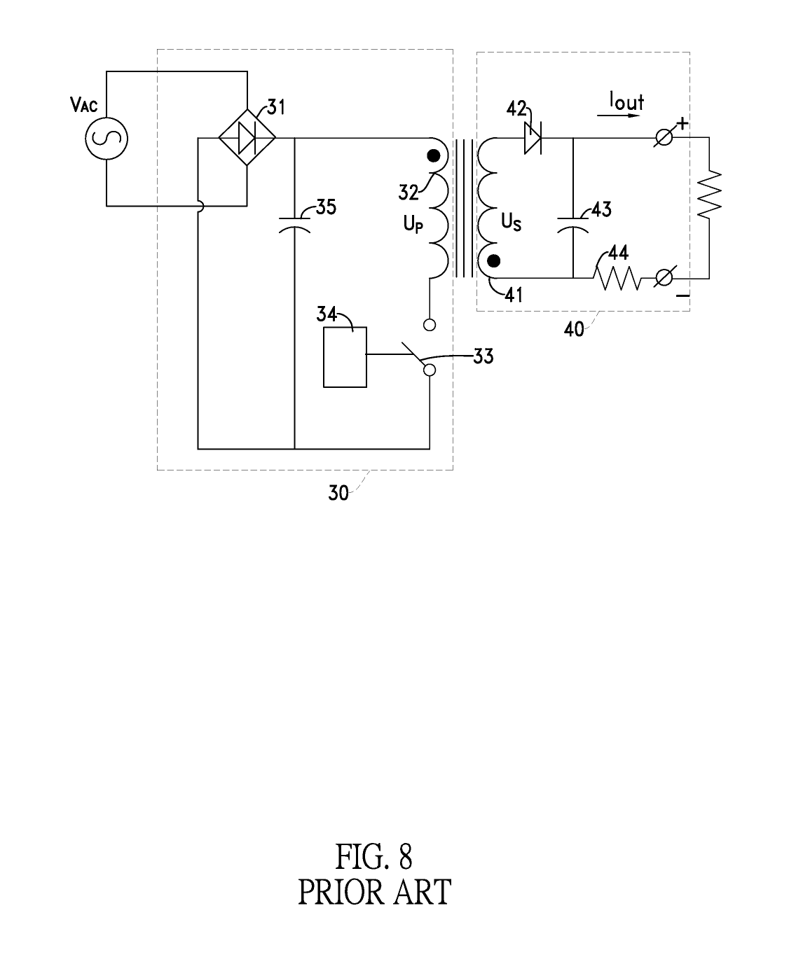

By observing FIGS. 7A to 7D, one can obtain that the time periods T_{SW}, T_{ON}, T_{OFF}, T_{dead} are determined by the voltage U_{S} of the switching node 24, such that the time periods T_{SW}, T_{ON}, T_{OFF}, T_{dead} can be obtained by sensing the voltage U_{S} of the switching node 24.

The following steps may be applied to obtain T_{OFF}, U_{S1} and T_{SW}:

(a) obtaining a first time period during which U_{S} is less than zero voltage (ground) by sensing U_{S}, wherein the first time period is T_{OFF} and U_{S} during T_{OFF} is a constant voltage U_{S1}; and

(b) obtaining a second time period from a start of a T_{OFF} to a start of a subsequent T_{OFF}, wherein the second time period is defined as T_{SW}.

Furthermore, a time period from an end of a T_{OFF} to an end of a subsequent T_{OFF} is also defined as T_{SW}.

A derivation of a method for sensing the output current Iₒᵤₜ of the fly-back converter as shown in FIG. 6 in accordance with the invention is revealed in the following paragraph.

The output voltage Uₒᵤₜ is controlled to a predetermined output voltage, and a total output energy Eₒᵤₜ in a single switching cycle of the fly-back converter is Uₒᵤₜ×Iₒᵤₜ×T_{SW}. By observing FIGS. 7C and 7D one can obtain that the secondary coil 21 only outputs the current I_{S} in the OFF stage, that is, the secondary coil 21 only releases energy in the OFF stage of the switching cycle of the fly-back converter. An energy E_{S} released by the secondary coil 21 in an OFF stage of a switching cycle is −U_{S1}×I_{Save}×T_{OFF}, wherein I_{Save} is an average induction current I_{S} of the secondary coil 21 in the OFF stage. In addition, diode 22 also consumes a diode energy E_{D} in an OFF stage of a switching cycle due to the forward voltage U_{D}, wherein the consumed diode energy E_{D}=U_{P}×I_{Save}×T_{OFF}. The energy E_{S} released by the coil 21 equals a sum of the output energy Eₒᵤₜ and the diode energy E_{D} in a duty cycle:

E_{S}=Eₒᵤₜ+E_{D}=−U_{S1}×I_{Save}×T_{OFF}=Uₒᵤₜ×Iₒᵤₜ×T_{SW}+U_{D}×I_{Save}×T_{OFF}.

(−U_{S1}−U_{D})I_{Save}×T_{OFF}=Uₒᵤₜ×Iₒᵤₜ×T_{SW}

By observing FIG. 7D we can obtain that the induction current I_{S} is decreased from a high current I_{S1} to 0 A in an OFF stage.

$$\frac{{dI}_{S 1}}{dt} = \frac{- {U}_{S 1}}{{L}_{S}}$$

$${dI}_{S 1} = \frac{- {U}_{S 1}}{{L}_{S}} dt$$

$${I}_{S 1} = \frac{- {U}_{S 1}}{{L}_{S}} {T}_{OFF}$$

and the waveform of the induction current I_{S} is triangular wave, that is, the average current

$${I}_{Save} = \frac{1}{2} {I}_{S 1} = \frac{1}{2} \frac{- U}{{L}_{S}} {T}_{OFF} . \\ \begin{matrix}( - {U}_{S 1} - {U}_{D} ) \times \frac{1}{2} {I}_{S 1} \times {T}_{OFF} = \frac{1}{2} \frac{- {U}_{S 1}}{{L}_{S}} {T}_{OFF} \times {T}_{OFF} \\ = {U}_{out} \times {I}_{out} \times {T}_{SW}\end{matrix}$$

$$( - {U}_{S 1} - {U}_{D} ) \times \frac{- {U}_{S 1} {T}_{OFF}^{2}}{2 {L}_{S}} = {U}_{out} \times {I}_{out} \times {T}_{SW}$$

$${I}_{out} = ( {U}_{S 1} + {U}_{D} ) \times \frac{{U}_{S 1} {T}_{OFF}^{2}}{2 {L}_{S} {U}_{out} {T}_{SW}} and ( {U}_{S 1} + {U}_{D} ) equals - {U}_{out}$$

$${I}_{out} = ( {U}_{S 1} + {U}_{D} ) \times \frac{{U}_{S 1} {T}_{OFF}^{2}}{2 {L}_{S} {U}_{out} {T}_{SW}} = \frac{- {U}_{S 1} {T}_{OFF}^{2}}{2 {L}_{S} {T}_{SW}} , wherein \frac{- 1}{2} ,$$

the U_{S1}, and the L_{S} are all known constants.

The formula

$${I}_{out} = \frac{- {U}_{S 1} {T}_{OFF}^{2}}{2 {L}_{S} {T}_{SW}} = k \frac{{T}_{OFF}^{2}}{{T}_{SW}} ,$$

wherein k is a constant and equals

$$\frac{- {U}_{S 1}}{2 {L}_{S}}$$

A method for sensing the output current Iₒᵤₜ of the fly-back converter as shown in FIG. 6 in accordance with the present invention comprises following steps:

(a) sensing the voltage U_{S} of the switching node 24 to obtain the time period T_{SW} of the switching cycle of the fly-back converter and the time period T_{OFF} of the OFF stage of the switching cycle; and

(b) calculating the output current Iₒᵤₜ according to formula:

$${I}_{out} = k \frac{{T}_{OFF}^{2}}{{T}_{SW}}$$

In conclusion, by the method for sensing the output current Iₒᵤₜ of the fly-back converter in accordance with the present invention, a user needs to sense a voltage U_{S} of the switching node 24, and then the output current Iₒᵤₜ of the fly-back converter can be obtained by the formula without sensing any current in the fly-back converter by a sensing resistor.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A method for sensing an output current of a fly-back converter, comprising the steps of:
sensing a voltage of a switching node of the fly back converter to obtain a time period T_{SW} of the switching cycle of a fly-back converter and a time period T_{OFF} of a OFF stage of the switching cycle; and
calculating an output current Iₒᵤₜ of the fly back converter according to a formula:
$${I}_{out} = k \frac{{T}_{OFF}^{2}}{{T}_{SW}}$$
wherein; the k is a constant; the T_{OFF} is a time period of the OFF stage of the switching cycle of the fly-back converter; the L_{S} is an inductance of the secondary coil of the fly back converter; the T_{SW} is a time period of the switching cycle of the fly-back converter.

2. The method as claimed in claim 1, wherein the step of sensing a voltage of the switching node of the fly-back converter comprises steps of:
obtaining a first time period during which the voltage of the switching node is greater than Uₒᵤₜ by sensing the voltage of the switching node, wherein the first time period is defined as T_{OFF} and the voltage of the switching node during T_{OFF} is a constant voltage U_{S1}; and
obtaining a second time period from a start of a T_{OFF} to a start of a subsequent T_{OFF}, wherein the second time period is defined as T_{SW}.

3. The method as claimed in claim 1, wherein the step of sensing an switching node of the fly-back converter comprises steps of:
obtaining a first time period during which the voltage of the switching node is less than zero voltage by sensing the voltage of the switching node, wherein the first time period is defined as T_{OFF} and the voltage of the switching node during T_{OFF} is a constant voltage U_{S1}; and
obtaining a second time period from a start of a T_{OFF} to a start of a subsequent T_{OFF}, wherein the second time period is defined as T_{SW}.

4. The method as claimed in claim 1, wherein the step of sensing an voltage of the switching node of the fly-back converter comprises steps of:
obtaining a first time period during which the voltage of the switching node is greater than Uₒᵤₜ by sensing the voltage of the switching node, wherein the first time period is defined as T_{OFF} and the voltage of the switching node during T_{OFF} is a constant voltage U_{S1}; and
obtaining a second time period from an end of a T_{OFF} to an end of a subsequent T_{OFF}, wherein the second time period is defined as T_{SW}.

5. The method as claimed in claim 1, wherein the step of sensing a voltage of the switching node of the fly-back converter comprises steps of:
obtaining a first time period during which the voltage of the switching node is less than zero voltage by sensing the voltage of the switching node, wherein the first time period is defined as T_{OFF} and the voltage of the switching node during T_{OFF} is a constant voltage U_{S1}; and
obtaining a second time period from an end of a T_{OFF} to an end of a subsequent T_{OFF}, wherein the second time period is defined as T_{SW}.

6. The method as claimed in claim 2, wherein the constant k equals
$$\frac{{U}_{S 1}}{2 {L}_{S}} ,$$
and the U_{S1} is the voltage of the switching node of the fly back converter in the OFF stage of the switching cycle of the fly-back converter, and the L_{S} is an inductance of the secondary coil of the fly back converter.

7. The method ac claimed in claim 4, wherein the constant k equals
$$\frac{{U}_{S 1}}{2 {L}_{S}} ,$$
and the U_{S1} is the voltage of the switching node of the fly back converter in the OFF stage of the switching cycle of the fly-back converter, and the L_{S} is an inductance of the secondary coil of the fly back converter.

8. The method as claimed in claim 3, wherein the constant k equals
$$\frac{- {U}_{S 1}}{2 {L}_{S}} ,$$
and the U_{S1} is the voltage of the switching node of the fly back converter in the OFF stage of the switching cycle of the fly-back converter, and the L_{S} is an inductance of the secondary coil of the fly back converter.

9. The method as claimed in claim 5, wherein the constant k equals
$$\frac{- {U}_{S 1}}{2 {L}_{S}} ,$$
and the U_{S1} is the voltage of the switching node of the fly back converter in the OFF stage of the switching cycle of the fly-back converter, and the L_{S} is an inductance of the secondary coil of the fly back converter.
